(19) United States
(12) Patent Application Publication
(10) Pub. No.: US 2018/0126824 A1
(43) Pub. Date: May 10, 2018

(54) AIR VENT FOR A MOTOR VEHICLE

(71) Applicant: Illinois Tool Works Inc., Glenview, IL (US)

(72) Inventors: Michael Demerath, Hüffler (DE); Andrew LeFever, Kaiserslautern (DE); Marek Prodelal, Jicín (CZ)

(73) Assignee: Illinois Tool Works Inc., Glenview, IL (US)

(21) Appl. No.: 15/576,095

(22) PCT Filed: May 28, 2016
(86) PCT No.: PCT/EP2016/061161

§ 371 Date: Nov. 21, 2017

(30) Foreign Application Priority Data
May 28, 2015 (DE) 10 2015 108 394.9

(51) Int. Cl. B60H 1/34

(52) U.S. Cl. CPC B60H 1/3421; B60H 2001/3478

(57) ABSTRACT

Air vent for a motor vehicle. The air vent includes a housing which creates a flow connection between an air inlet region and an air outlet region. A lamellar carrier is movably mounted in the housing. The air vent also includes a blocking element which can be moved between a closed position in which said element blocks the flow connection and an open position in which said element releases the flow connection. The lamellar carrier and the blocking element are parts of a push-push mechanism which which is activatable by overpressing the lamellar carrier from a specific use position into an operation direction. The lock element changes its position by the activation of the push-push mechanism.

### BACKGROUND OF THE DISCLOSURE

The invention relates to an air vent for a motor vehicle.

Air vents for motor vehicles serve for the ventilation of the interior of the vehicle by guiding the air flow through an air channel and through the air vent into the interior. As a rule, an air vent comprises several adjustable lamellae to influence the air flow in a targeted manner. If the air vent is not needed, the lamellae or a closing flap can be brought into a closed position where no or almost no air from the associated air channel can reach the interior of the vehicle.

From the DE 16 15 223 B4 an air vent manipulation installation is known which comprises a nozzle housing with an outlet opening facing the interior of the vehicle, and an inlet opening which is associated with the end of an air channel. In the housing a rotation frame with a closing part designed as a panel body and bulkhead parts formed thereto can be swiveled around a rotary shaft. For a complete prevention of the air flow emission the rotary frame can be swiveled in such a way that the air guiding vanes are moved into the interior of the housing and the panel body covers the outlet opening.

In the DE 20 2010 008 054 U1 an air vent is shown with a housing which is extended into an outlet opening in form of a hemisphere. In this extension a flow guiding part with adjustable lamellae is arranged in a swiveling manner. The flow guiding part comprises an annular holder with a boss and connecting bridges which hold lamellae in a swivel-movable manner. A lockable operation button is provided for a combined adjustment of all lamellae, which is held in the boss of the holder. In a non-locked first position the actuator button protrudes. In this position the lamellae are oriented in a spot ventilation system and by means of the actuator button the flow guiding part can be swiveled relatively to the housing. In a second locked position achievable by pressing the actuator button the lamellae are adjusted in a diffused ventilation system. The rest connection of the actuator button is resolvable. By overpressing the actuator button it automatically retakes the first position.

### BRIEF DESCRIPTION OF THE DISCLOSURE

In an embodiment, an air vent for a motor vehicle is provided. The air vent includes a housing which creates a flow connection between an air inlet region and an air outlet region. A lamellar carrier is movably mounted in the housing. The air vent also includes a blocking element which can be moved between a closed position in which said element blocks the flow connection and an open position in which said element releases the flow connection. The lamellar carrier and the blocking element are parts of a push-push mechanism which is activatable by overpressing the lamellar carrier from a specific use position into an operation direction. The lock element changes its position by the activation of the push-push mechanism.

### BRIEF DESCRIPTION OF THE DRAWINGS

Further features and advantages of the invention result from the following description and from the attached drawings reference is made to. The drawings show the following:

FIG. 1 a first embodiment of the air vent according to the invention in a first operation position in a perspective view;

FIG. 2 the air vent of FIG. 1 in the first operation position in a side view:

FIG. 3 the air vent of FIG. 1 without housing in the first operation position in a lateral sectional view;

FIG. 4 the air vent of FIG. 1 without housing in a second operation position in a lateral sectional view;

FIG. 5 the air vent of FIG. 1 without housing in the second operation position with swivel lamellae carrier in a lateral sectional view;

FIG. 6 a second embodiment of the air vent according to the invention in a first operation position in a perspective view;

FIG. 7 the air vent of FIG. 6 without housing in the first operation position in a lateral sectional view;

FIG. 8 the air vent of FIG. 6 in a second operation position in a perspective view;

FIG. 9 the air vent of FIG. 6 without housing in the second operation position in a lateral sectional view;

FIG. 10 a third embodiment of the air vent according to the invention in a first operation position in a lateral sectional view;

FIG. 11 the air vent of FIG. 10 with overpressed lamellae carrier in a lateral sectional view;

FIG. 12 the air vent of FIG. 10 in the second operation position in a lateral sectional view;

FIG. 13 the air vent of FIG. 10 in the second operation position in a lateral sectional view without lamellar carrier;

FIG. 14 a fourth embodiment of the air vent according to the invention in an exploded view;

FIG. 15 the air vent of FIG. 14 in a first operation position in a perspective view;

FIG. 16 the air vent of FIG. 14 in the first operation position in a semitransparent side view;

FIG. 17 the air vent of FIG. 14 in the first operation position with a swiveled lamellae carrier in a semitransparent side view;

FIG. 18 the air vent of FIG. 14 in a second operation position in a semitransparent side view;

FIG. 19 a first and a second variant of a fifth embodiment of the air vent according to the invention in an exploded view;

FIG. 20 the air vent of FIG. 19 according to the first variant in a first operation position in a perspective view;

FIG. 21 the air vent of FIG. 19 according to the first variant in the first operation position in a semitransparent side view;

FIG. 22 the air vent of FIG. 19 according to the first variant in a second operation position in a semitransparent side view;

FIG. 23 the air vent of FIG. 19 according to the second variant in a first operation position in a semitransparent side view; and

FIG. 24 the air vent of FIG. 19 according to the second variant in a second operation position in a semitransparent side view.

### DETAILED DESCRIPTION OF THE DISCLOSURE

The object of the invention is to create an air vent by means of which the outflow of the air can be prevented and released in a simple manner without requiring a separate operating element.

This object is met by an air vent with the features of claim 1. Advantageous and appropriate embodiments of the air vent according to the invention are specified in the dependent claims.

The air vent according to the invention comprises a housing which provides a flow connection between an air inlet region and an air outlet region. A lamellae carrier is movably mounted in the housing. The air vent further comprises a lock element which is movable between a closed position where it locks the flow connection, and an open position where it releases the flow connection. According to the invention the lamellae carrier and the lock element are parts of a push-push mechanism which is activatable by overpressing the lamellae carrier from a particular use position into an operation direction. By the activation of the push-push mechanism the lock element changes its position.

The invention is based on the finding that a push-push mechanism is ideally suitable to cause a switch between two defined mechanical states. Push-push mechanisms have been established in other technical fields as solutions which are simple and can be operated in an intuitive way, for example in ballpens, snapping push buttons and closures, for example drawers. This concept is now realized in a particular manner in an air vent for a motor vehicle, to release or lock the air supply through the air vent into the interior of the vehicle as desired by the user.

The operation of the push-push mechanism in the air vent according to the invention is not realized by means of a separate operation element, such as a push button or a setting wheel. Instead, the user simply pushes on the lamellae carrier of the air vent, independently of its specific configuration (barrel insert, spherical insert etc.). In this way a separate operation element, the only function of which would be to open and close a flap of the air vent, can be dispensed with. The gained assembly space can be used to enlarge the air outlet opening or for other components.

Depending on the installation situation, type and design of the air vent, the operation direction for the activation of the push-push mechanism can vary. According to a first concept the operation direction follows a curve which is determined by the mounting of the laminar carrier. At its simplest, the curve can be a circular arc if the lamellae carrier in operation can be adjusted around a rotary axis.

In air vents where the lamellae carrier is configured as a so-called barrel insert the lamellae carrier is usually mounted in the housing in a swivelable manner. In these embodiments the invention provides that the push-push mechanism can be activated by overpressing starting from a defined end position of the lamellar carrier. This means that the lamellae carrier is adjusted by the user by swiveling into a defined operation direction and after the defined end position is reached it is still further swiveled into this direction to lock or release the air supply.

The defined end position of the lamellae carrier can be defined by a stop. This is reasonable in case the defined end position corresponds to a normal use position of the lamellar carrier. The stop provides a tactile feedback to the user so that he does not unintentionally overpress the lamellae carrier and release the push-push mechanism.

The lamellae carrier and its defined end position can also be configured in a way that the lamellae carrier comprises a cover which covers an air outlet opening of the air vent in the defined end position. In this case a stop is not absolutely necessary because it is suggestively indicated to the user that a further swiveling into the operation direction will result in a blockade of the air supply. The cover itself can be configured as desired by the vehicle manufacturer.

According to a second concept of the invention the operation direction the lamellae carrier is overpressed into for the activation of the push-push mechanism is essentially linear. This does also include small deviations from a straight line.

This concept is in particular appropriate for lamellar carriers which are not mounted to be swivelable around a rotary axis. For this case the invention provides the lamellae carrier being movably mounted in the housing and the push-push mechanism is activated by pushing the lamellae carrier into the housing. Also for this concept no separate operation element in addition to the air outlet opening is required but the switch between release and interruption of the air supply is realized by simple pushing on any side of the lamellae carrier which is accessible to the user.

The lock element by means of which the flow connection in the air vent between the air inlet region and the air outlet region can be locked and released is preferably coupled to the lamellae carrier via a lever construction. With the lever construction the movement of the lamellae carrier while overpressing into the moving direction can be effectively converted into a given movement of the lock element that it automatically changes its position. If, for example, the lamellae carrier is swivelably mounted and the lock element is a ratably mounted flap, the lever construction can convert the short swivel course into a 90° rotation of the flap while overpressing.

In particular preferred embodiments of the air vent according to the invention the lever construction comprises a rocker element which is swiveled when overpressing the lamellar carrier, and a rotary element which rotates the lock element into the open or into the closed position by the swivel movement of the rocker element. By means of the rocker element and the rotary element a flap serving as a lock element can be rotated into the open or into the closed position in an effective and reliable manner to optionally release and interrupt the flow connection between the air inlet region and the air outlet region of the air vent.

According to a first design principle the lever construction further comprises a rest lever which can hold the rocker element in two defined positions. The additional rest lever also takes care that the rocker element can be held in a first position where the lock element releases the flow way by coupling with the rotary element, and in a second position where the lock element blocks the flow way. Depending on the installation situation it can be reasonable to pre-tension the rest lever so that it exhibits a defined behavior. Where appropriate, for this purpose alternatively the self-weight of the rest lever can be exploited.

The cooperation of the rest lever and the rocker element is preferably realized by means of a heart slotted link guide of the rocker element wherein an extension of the rest lever engages with said heart slotted link guide and can take two stable rest positions therein.

According to a second design principle the push-push mechanism comprises a control element which cooperates with an extension, preferably a leaf or catch spring, which can take two stable positions. Therefore, here a control element is provided instead of the rest lever to realize the two stable positions of the lock element.

The control element can be attached to the housing, and the extension, in particular a lope section, can be provided at the rotary element. Alternatively, also the control element can be provided at the rotary element and the extension can be attached to the housing.

The transfer of the swivel movement of the rocker element to a rotary movement of the rotary element which entrains the lock element can be realized via engaging toothings of both elements. This solution results in a particular homogeneous power transmission.

An alternative coupling of the rocker element to the rotary element provides an extension which slides at the rotary element or at the rocker element in a guide at the rocker element or at the rotary element, respectively, said guide is adjusted to the extension. Such a solution is particularly simple and cost-effective.

The lock element for the optional release and interruption of the flow connection between the air inlet region and the air outlet region of the air vent can also be provided directly at the lamellar carrier. In particular, a wall of the lamellae carrier can function as lock element if, in a position corresponding to that of the lamellae carrier, it seals towards the housing of the air vent.

In principle there are several possibilities for the concrete implementation of the actual push-push mechanics of the air vent according to the invention. In all preferred options the push-push mechanism comprises an extension which, when activating the push-push mechanism, is alternatingly detained and released by a push-push unit or is alternatingly detained in the push-push unit in two different stable positions.

The extension can for example be formed at the lever construction. The associated push-push unit is then appropriately fixed to the housing, i.e. either directly formed at the housing or it is provided at the housing in a manner that it is immobile in relation to the housing.

Alternatively, the push-push mechanism can also act between the lamellae carrier and the housing. In this case the extension is positioned or mounted at the housing and the push-push unit is provided at the lamellae carrier or vice versa.

Another possible implementation provides that the extension is formed at the lock element and the push-push unit is attached to the housing.

In any case it is advantageous, after a switch of the lock element into the closed position, to pretention the lamellae carrier spring element into a use position. In this way it is ensured that after the overpressing the lamellae carrier does not unintentionally remain in the overpressed position but automatically returns into a use position. This use position can in particular be a defined middle or neutral position where the lamellae carrier is e.g. end flush with a frame around the air outlet opening.

In particular embodiments it is reasonable to pretension the lock element by a spring element into the open or into the closed position. This concerns in particular embodiments where the lock element after the release by the push-push mechanism is not automatically transferred into any of the two possible positions by a lever mechanism.

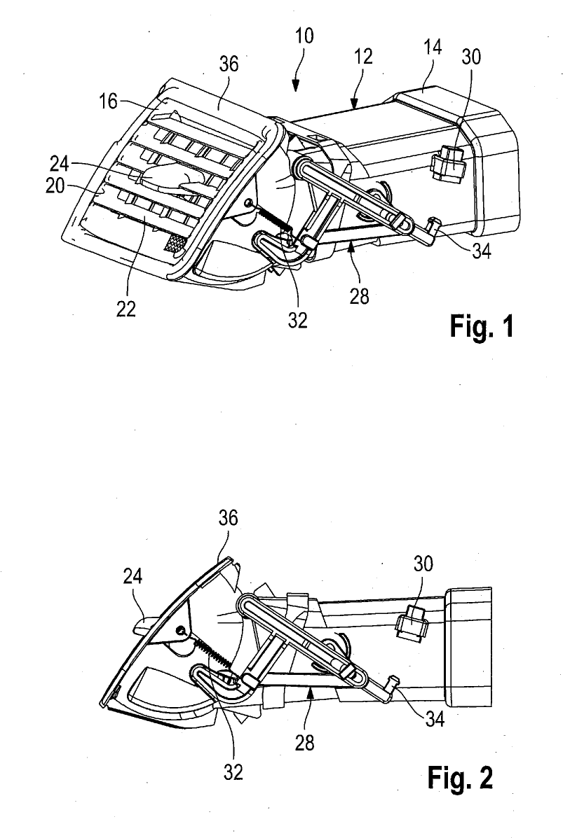

In the FIGS. 1 to 5 a first embodiment of an air vent 10 fora motor vehicle is shown. The air vent 10 comprises a housing 12 with a connecting piece 14 in a rear air inlet region and an air outlet opening 16 in a front air outlet region. In the mounted state of the air vent 10 the connecting piece 14 is connected to an air channel of the vehicle, and the air outlet opening 16 flows into the interior of the vehicle. The housing 12 creates a flow connection between the air inlet region and the air outlet region in a manner that the air provided via the air channel can flow into the interior of the vehicle.

In the air outlet region of the air vent 10 a lamellae carrier 18 is swivelably mounted in the housing 12. The lamellae carrier 18 is swivelable as a whole around a horizontal rotary axis A. The rotary axis A penetrates the lamellae carrier 18 at about half of its vertical height. The normal swivel range of the lamellae carrier 18 is determined by two stops which, during the normal operation of the air vent 10, define an upper and a lower end position. An upper end position refers to such a position where the lamellae carrier 18 can be adjusted to its maximum into a first operation direction by pressing on a region above the rotary axis A, until it touches the first stop. Correspondingly, the lower end position is such a position where the lamellae carrier 18 can be adjusted to its maximum in a second operation direction opposite to the first operation direction by pressing on a region below the rotary axis A until it touches the second stop.

The lamellae carrier 18 includes a partly cylindrical frame 20 (“barrel type”) where several horizontal lamellae 22 are fixedly or swivelably mounted around horizontal axes. Additionally also vertical lamellae can be provided which can also be swiveled around vertical axes. An operating element is provided on one of the horizontal lamellae 22, by means of which the lamellae carrier 18 as a whole and/or the horizontal or vertical lamellae can be swiveled.

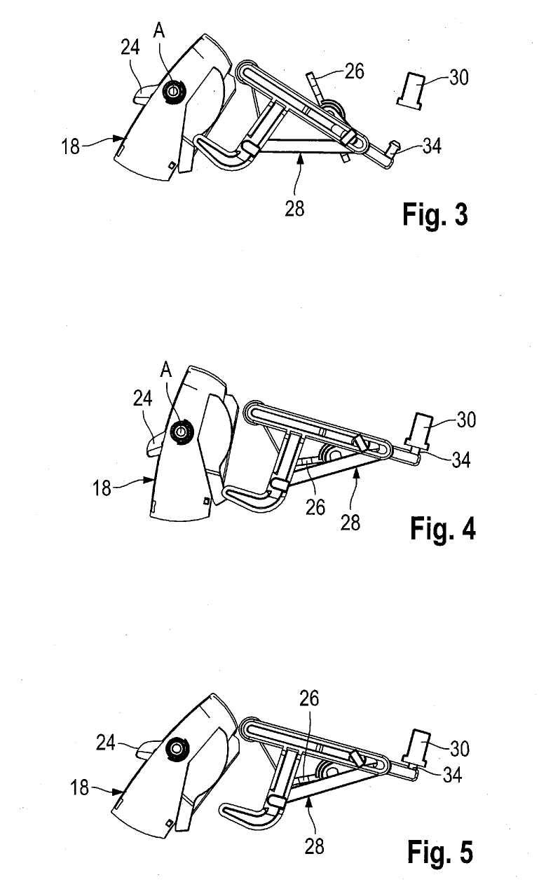

The air vent 10 further comprises a lock element 26, here in form of a flap, which is provided for the interruption of the flow connection between the air inlet region and the air outlet region, In an opened position the lock element 26 is parallel to the flow direction so that the flow connection is released (see FIGS. 4 and 5). In a closed position the lock element 26 covers essentially at a certain place the entire flow area of the housing 12 so that almost no air can get through from the air channel to the air outlet opening 16 (see FIG. 3). The lock element 26 can optionally be moved back and forth between these two positions as explained in the following in more detail.

The lamellae carrier 18 and the lock element 26 are components of a push-push mechanism which allows by manual pushing on the lamellae carrier 18 to operate the lock element 26, i.e. to convert the lock element 26 from the open position into the closed position and vice versa. The lamellae carrier 18 is coupled to the lock element 26 via a lever construction 28. The majority of the lever construction 28 is laterally positioned at the housing 12 in order to not influence the flow progression in the housing 12. This is, however, not compellingly necessary. The push-push mechanism also includes a push-push unit 30 which is here also attached laterally at the housing and interacts with the lever construction 28. The assembly of the push-push mechanism results from the following functional description of the air vent 10.

In the following it is assumed that the lock element 26 is in the closed position as shown in FIG. 3. Since the lock element 26 locks the flow connection between the air inlet region and the air outlet region, the air supply through the air vent 10 into the interior of the vehicle is also interrupted.

If the lamellae carrier 18 is now swiveled by a user into the lower end position and beyond the lower end position by several millimeters by overpressing against the resistance of a spring element 32 into the second operation direction, the push-push mechanism is thereby activated (triggered). The lamellae carrier 18 thereby acts upon the lever construction 28 so that on the one hand the coupled lock element 26 switches into the open position. On the other hand an extension 34 of the lever construction 28 is guided into the push-push unit 30 and detained by it so that the lever construction 28 remains with the lock element 26 in the open position (see FIG. 4).

In the open position of the lock element 26 the air provided from the air channel can freely flow through the housing 12 of the air vent 10 and into the interior of the vehicle through the lamellae carrier 18 with the lamellae 22. The lever construction 28 is configured in a manner that in this normal operation position of the air vent 10 a swiveling of the lamellae carrier 28 within the swivel area determined by both stops has no effect on the lock element 26 (see FIG. 5).

In order to interrupt the flow connection the lamellae carrier 18 is again swiveled beyond the lower end position by several millimeters by overpressing against the resistance of the spring element 32 into the second operation direction so that thereby the push-push mechanism is activated. The push-push unit 30 releases the lever extension 34 so that, after the user has released the lamellae carrier 18, the spring element 32 conveys the lever construction 28 again into the position as shown in the FIGS. 1 to 3 and holds it there. At the same time the lock element 26 switches back into the closed position and remains in this position. Furthermore, due to the spring element 32 the lamellae carrier 18 is automatically conveyed back into the regular swivel area, more precisely into a middle position where the lamellae carrier 18 is nearly flush with the frame 36 of the air outlet opening 16.

The end position of the lamellae carrier 18 from which the push-push mechanism is activated needs not necessarily be the lower end position. The push-push mechanism can also be configured that the activation by overpressing in the first operation direction occurs beyond the upper end position. Furthermore, for another installation situation a left or right and also a transverse end position can be the starting point for the activation.

Instead of the lever construction 28 being provided outside at the housing 12 other constructions with the same functionality can be used.

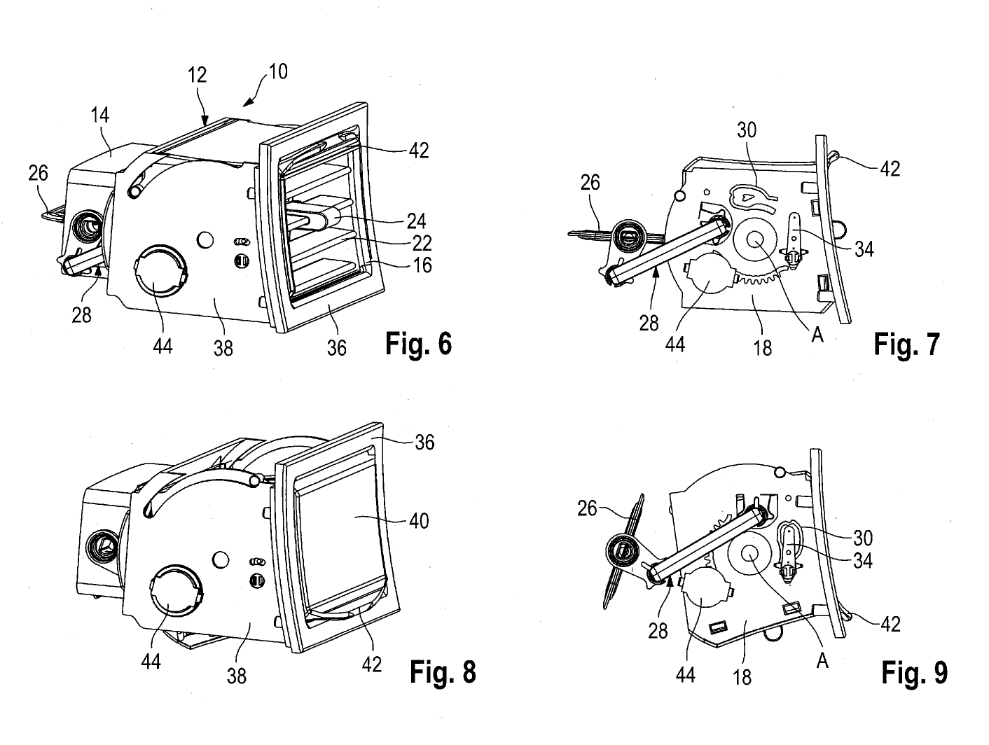

In the FIGS. 6 to 9 a second embodiment of an air vent 10 for a motor vehicle is shown. Components with the same or similar function have the same reference numbers as in the first embodiment.

The second embodiment differs from the first embodiment as previously described among others by the swivel area of the lamellae carrier 18 as being significantly enlarged in the second operation direction. In addition, in contrast to the first embodiment the lever construction 28 which operates between the lamellae carrier 18 and the lock element 26 is largely positioned within a housing part 38 which surrounds the front part of the air inlet region of the air vent 10. The push-push unit 30 is here essentially formed by a heart slotted link guide provided at the outside of the lamellae carrier 18, which cooperates with an extension 34 which is ratably mounted at the inside of the housing part 38. Of course, the extension 34 and the heart slotted link guide can also be positioned interchangeably.

Starting from the operation position of the air vent 10 with the lock element 26 in the open position as shown in the FIGS. 6 and 7, the lamellae carrier 18 can be swiveled into the lower end position as shown in the FIGS. 8 and 9. In the lower end position of the lamellae carrier 18 the lamellae 22 are completely swiveled into the air inlet region, i.e. when seen from the interior of the vehicle, no lamellae 22 can be seen in the air outlet opening 16. The air outlet opening 16 is rather covered by a cover 40 of the lamellae carrier 18, which is directly associated with the lamellae 22. By swiveling into the lower end position also the lock element 26 which is coupled to the lamellae carrier 18 via the lever construction 28 is transferred into the closed position.

For swiveling into the lower end position the user can push on a region of the lamellae carrier 18 below the rotary axis A or he can pull the lamellae carrier 18 into the second operation direction at a gripper section 42 of the cover 40 protruding from the air outlet opening 16. In any case the swiveling of the lamellae carrier 18 occurs against the pre-tension force of a spring element (not shown in the FIGS. 6 to 9) so that the second end position is not stable.

If, however, the lamellae carrier 18 is swiveled beyond the lower end position by pressing on the lower region of the cover 40 at the gripper section 42, the push-push mechanism is thereby activated. After the user has released the lamellae carrier 18 the extension 34 takes a stable position in the heart slotted link guide of the push-push unit 30 by the aid of a pretension force of the spring element. In doing so, the lamellae carrier 18 is held against the pretension force of the spring element in the position as shown in FIGS. 8 and 9, where the lock element 26 blocks the flow connection between the air inlet region and the air outlet region.

In order to release the flow connection, the lamellae carrier 18 needs again to be swiveled beyond the lower end position by overpressing. The push-push unit 30 releases the extension 34 and the pretension force of the spring element automatically conveys the lamellae carrier 18 back into the regular swivel area where the lamellae 22 are again visible and can exert their intended function. Due to the lever construction 28 the lock element 26 automatically switches into the open position.

Similar to the first embodiment the end position of the lamellae carrier 18 where the air outlet opening 16 is covered by the cover 40 and from which the push-push mechanism is activated, need not compellingly to be the lower end position. The push-push mechanism can also be arranged in a manner that the activation occurs by overpressing into the first operation direction beyond the upper end position. Likewise, in another installation situation a left or right but also a traverse end position can be the starting point for the activation.

In this embodiment an additional damper 44 is provided ensuring that the swivel movement of the lamellae carrier 18 supported by the force of the spring is slower.

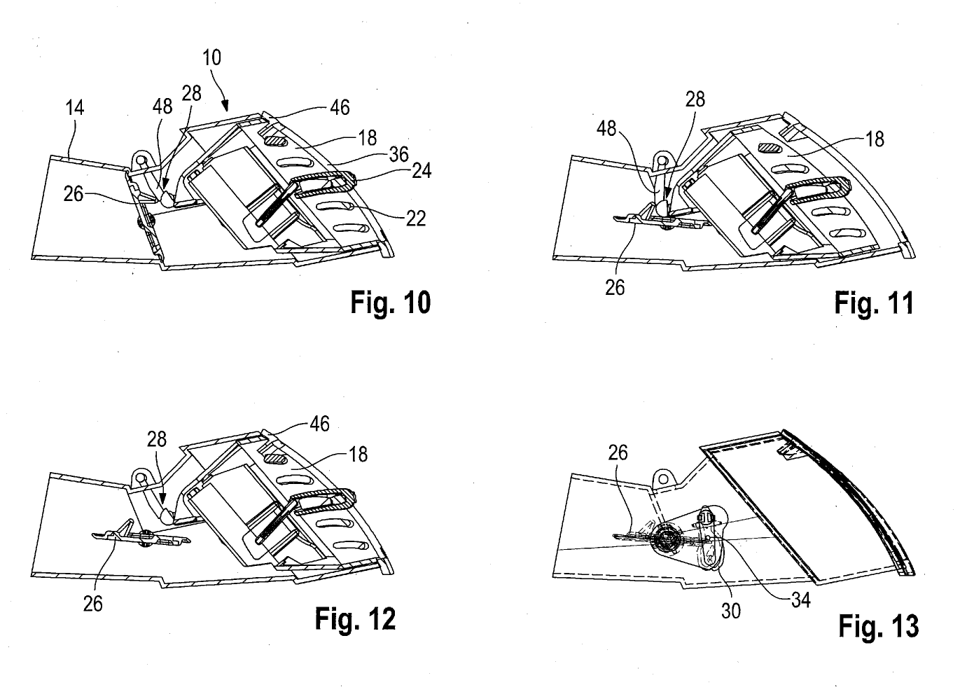

In the FIGS. 10 to 13 a third embodiment of an air vent 10 for a motor vehicle is shown. Components with the same or similar functions have again the same reference numbers as in the first two embodiments.

Irrespective of an optionally possible swivelability of the lamellae carrier 18 and/or the lamellae 22 in this embodiment the lamellae carrier 18 is mounted in the front area of the housing (air inlet region) in a movable manner. A spring element (not shown in the FIGS. 10 to 13) is provided which pretensions the lamellae carrier 18 to the front, i.e. into the direction of the air outlet opening 16 against a stop 46. At a normal use of the air vent 10 the lamellae carrier 18 is in this position.

Like in the first two embodiments the lamellae carrier 18 and the lock element 26 are components of a push-push mechanism which also includes the spring element. In turn, a lever construction 28 with a link 48 couples the rotably mounted lock element 26 to the lamellae carrier 18. The lock element 26 is pretensioned in the closed position by said spring element or an additional spring element. An extension 34 of the lock element 26 interacts with the push-push unit 30 attached to the housing, which are both shown in FIG. 13 only.

In contrast to the two other embodiments the push-push mechanism is not activated by swiveling the lamellae carrier 18 around a rotary axis but by moving the lamellae carrier 18 to the back into the housing 12, that means into the direction of the connecting piece 14. Here this direction is referred to as operation direction.

If the lock element 26 is in the closed position, the lamellae carrier 18 can be moved from the normal position as shown in FIG. 10 against the resistance of the spring element(s) by several millimeters in operation direction into the housing 12, as shown in FIG. 11. Thereby the lever construction 28 ensures that the lock element 26 switches from the closed position into the open position. By swiveling the lock element 26 the push-push mechanism is activated. The extension 34 of the lock element 26 is guided into the push-push unit 30 and is detained therein. For this reason the lock element 26 maintains in the open position if the pretension force of the spring element(s) pushes the lamellae carrier 18 back again into the normal use position (see FIG. 12).

If the lamellae carrier 18 is again pushed in operation direction into the housing 12 then the lock element 26 is swiveled in a manner that the push-push mechanism is activated and releases the extension 34 of the lock element 26. Immediately thereafter the lock element 26 is automatically switched into the closed position due to the pretension force. The lamellae carrier 18 is also pushed into the normal use position due to the pretension force.

Depending on the installation situation and the form of the housing 12 the movement of the lamellae carrier 18 is linear or along a predetermined curve, i.e. the operation direction is either straight or curved.

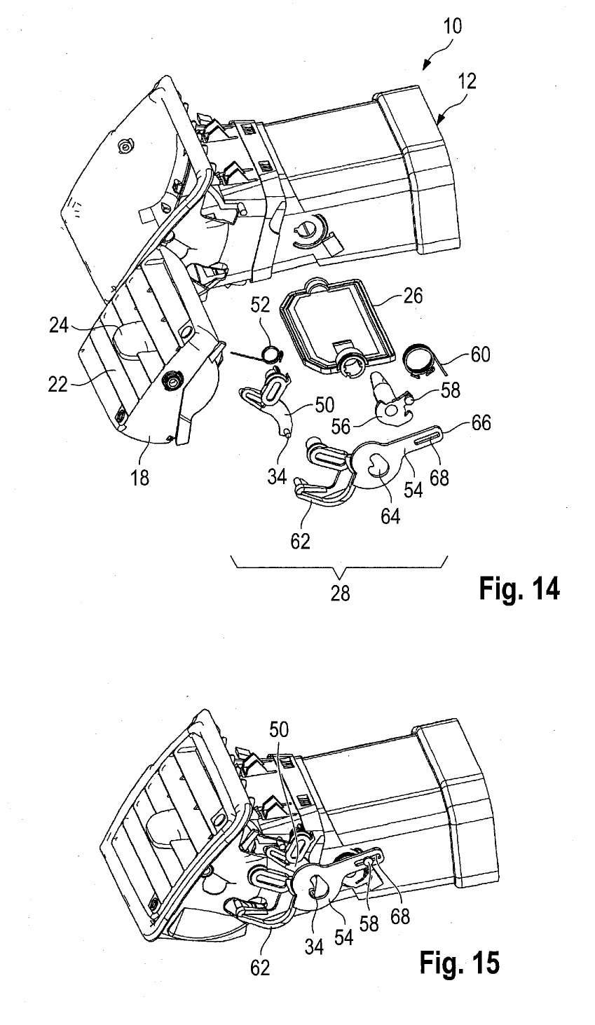

A fourth embodiment of an air vent 10 for a motor vehicle is shown in the FIGS. 14 to 18. Components with the same or similar functions have the same reference numbers as in the previously described embodiments.

The fourth embodiment is similar to the first embodiment insofar as here also the lamellae carrier 18 as a whole can be swiveled around a horizontal rotary axis A which penetrates the lamellae carrier 18 at about half of its vertical height. The normal swivel area of the lamellae carrier 18 is determined by two stops which define at the normal operation of the air vent 10 an upper and a lower end position.

In addition to the lamellae carrier 18 and the lock element 26 here the push-push mechanism includes a rest lever 50 with an extension 34 extending into axial direction, an optional rest spring element 52, a rocker element 54, a rotary element 56 with an eccentrical pin 58 extending into axial direction, and a lock spring element 60. The rocker element 54 has a fork shaped section 62, a middle recess 64 and an end section opposite to the fork shaped section 62, where an elongated guide 68 is provided.

Here the lever construction 28 which couples the lamellae carrier 18 to the lock element 26 is composed of the rocker element 54 and the rotary element 56. The fork shaped section 62 of the rocker element 54 interferes with the lamellae carrier 18 so that the rocker element 54 is deflected if the lamellae carrier 18 is deflected beyond the normal swivel area, as explained in more detail at a later stage. The rocker element 54 is coupled to the rotary element 56 via the pin 58 which engages with the guide 68. The rotary element 56 in turn is coupled to the lock element 26 via the lock spring element 60 which is a leg spring in the shown embodiment.

In the fourth embodiment the push-push unit 30 essentially consists of the middle recess 64 of the rocker element 54 the extension 34 of the rest lever 50 engages with. The middle recess 64 forms a heart slotted link guide for the extension 34. The rest lever 50 is mounted at the housing 12 of the air vent 10 in a swiveling manner and is pretensioned to the button by the rest spring element 52 according to the illustration of the FIGS. 15 to 18.

If the installation situation of the air vent 10 in the vehicle conforms with this illustration and the swivel axis A of the lamellae carrier 18 essentially conforms with the transverse direction (y direction) of the vehicle, the rest spring element 52 can be dispensed with since the rest lever 50 is “pretensioned” to the button because of its self weight. However, if the air vent 10 is mounted in a manner that the swivel axis A of the lamellae carrier 18 essentially conforms to the vertical direction (z direction) of the vehicle, the rest spring element 52 is compellingly necessary.

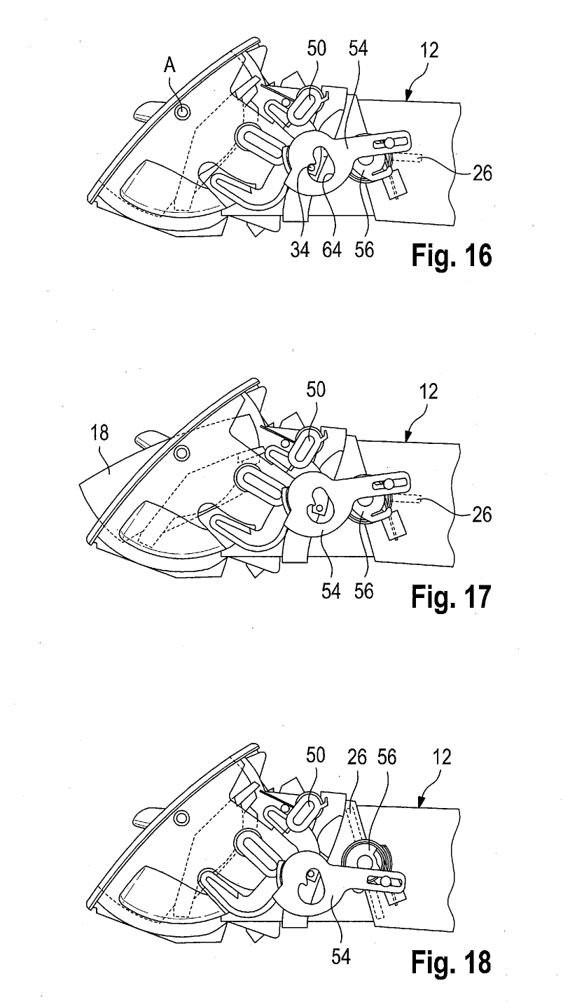

In the FIGS. 15 and 16 the air vent 10 is shown in a first operation position where the lock element 26 is in the open position. The lock spring element 16 pretensions the rotary element 56 in clockwise direction so that the lock element 26 strives to take the closed position. However, the rest lever 50 with the extension 34 prevents that the rocker element 54 can be swiveled in clockwise direction. To be precise, the extension 34 is locked in a first stable position which does not allow a clockwise swiveling of the rocker element 54. That means that the end section 66 of the rocker element 54 holds the rotary element 56 and thus the lock element 26 in an open position as shown in the FIGS. 15 and 16. The lamellae carrier 18 can therefore be swiveled within its normal swiveling area without having effects on the position of the lock element 26.

To transfer the air vent 10 from the first operation position into the second operation position where the lock element 26 is in the closed position, the lamellae carrier 18 is swiveled beyond the upper end position by several millimeters, as shown in FIG. 17. In doing so, the push-push mechanism is triggered by the counter clockwise deflection of the rocker element 54 where its heart slotted link guide releases the extension from the first stable rest position. The pretension of the lock spring element 60 ensures that the rotary element 56 and the lock element 26 are clockwisely swiveled until the extension 34 of the rest lever 50 reaches a second stable rest position and the lock element 26 reaches the closed position (see FIG. 18). As a result, also in the second operation position with a closed locking element 26 the lamellae carrier 18 can be swiveled within the normal swivel area.

For a switch back into the first operation position the lamellae carrier 18 is swiveled by several millimeters beyond the lower end position via overpressing. In doing so, the rocker element 54 is again counter clockwisely swiveled due to the fork shaped section 62 so that the push-push mechanism is reactivated. To be precise, by swiveling the rocker element 54 the lock element 26 is pushed into the open position and at the same time the extension 34 of the rest lever 50 is moved out of the second stable rest position of the heart slotted link guide. After releasing the lamellae carrier 18 the lock spring element 16 tries to swivel back the rocker element 54 into clockwise direction. However, this is immediately interrupted as soon as the extension 34 of the rest lever 50 is engaged with the heart slotted link guide in the first stable position. As a consequence, the lock element 26 remains in the open position.

The lever construction 28, in particular the fork shaped section 62 of the rocker element 54, can also be configured that the switch from the first operation position with open lock element 26 into the second operation position with closed lock element 26 is reached by swiveling the lamellae carrier 18 beyond the lower end position and vice versa. Likewise, the lever construction 28 can be configured as in the previous embodiments that a switch between the two operation positions can only be reached by swiveling beyond the upper end position or by swiveling beyond the lower end position, respectively.

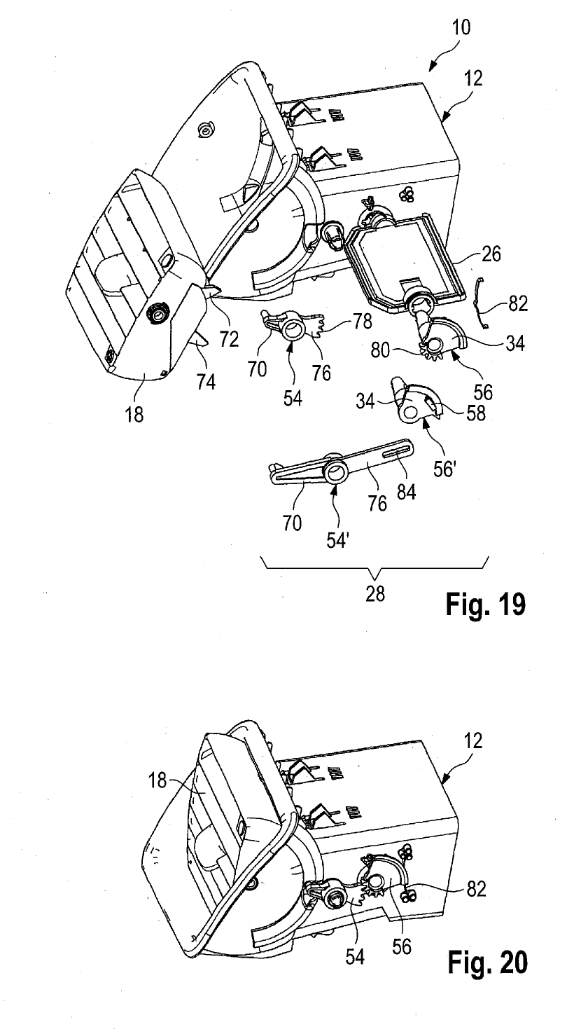

In FIG. 19 the components of a first and an alternative second variant of a fifth embodiment of an air vent 10 for a motor vehicle are shown. Components with the same or similar functions have again the same reference numbers as in the previously described embodiments. At first, the first variant of the fifth embodiment is described by referring to the FIGS. 20 to 22.

Here the lever construction 28 which couples the lamellae carrier 18 to the lock element 26 comprises a rocker element 54 and a rotary element 56. A first section 70 of the rocker element 54 protrudes into an area between two end stops 72, 74 of the lamellae carrier 18. A second section 76 of the locker element 54 opposite to the first section 70 comprises a toothing 78 which is adjusted to a toothing 80 of the rotary element 56. In opposite to the toothing 80 the rotary element 56 comprises an extension 34, here in form of a radially protruding lobe section. The lobe section extends into the rotary direction of the rotary element 56 over a particular angle. The rotary element 56 interacts with a control element attached to the housing, in particular with a leaf or catch spring 82, which has a preferential position and can be transferred into a deflection position where it can be stably held. There the leaf or catch spring 82 essentially forms the push-push unit 30.

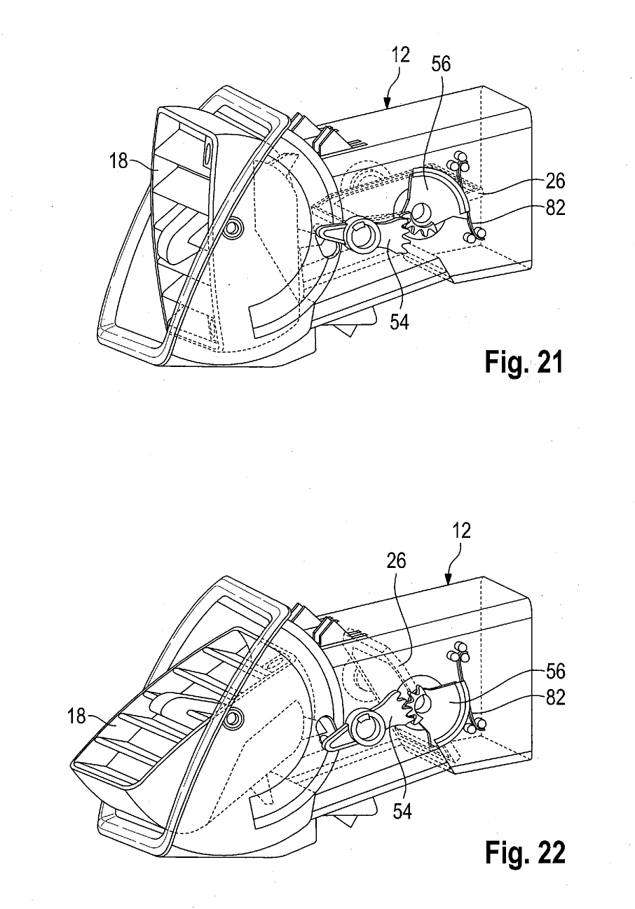

In the FIGS. 20 and 21 the air vent 10 is shown in a first operation position where the lock element 26 is in the open position. The leaf or catch spring 82 is here in its preferential position and holds the rotary element 56 in a certain angular position. A defined position of the first section 70 of the rocker element 54 results from the coupling of the rotary element 56 to the rocker element 54 due to their toothings 80 and 78, respectively. The normal swivel area of the lamellae carrier 18 is the angular range which can be passed by the lamellae carrier 18 until it touches any of the two end stops 72, 74.

To transfer the air vent 10 from this first operation position into the second operation position which is shown in FIG. 22 where the lock element 26 is in the closed position, the lamellae carrier 18 is swiveled beyond the upper end position by several millimeters. In doing so, the push-push mechanism is triggered. Thereby, the upper end stop 72 entrains the first section of the rocker element 54 and swivels it counter clockwisely. The engaging toothings 78, 80 ensure that the rotary element 56 and thus, in turn, the lock element 26 rotate clockwisely. For the rotation of the rotary element 56 at first the resistance of the leaf or catch spring has to be overcome. The rotation is terminated if the extension 34 (lobe section) of the rotary element 56 has transferred the leaf or catch spring 82 into the stable deflection position. In this rotated position the lock element 26 is in the closed position. In the so reached second operation position of the air vent 10 the lamellae carrier 18 can be swiveled without any effects on the lock element 26.

For a switch back into the first operation position the lamellae carrier 18 is swiveled beyond the lower end position for several millimeters by overpressing. In doing so, exactly the opposite movement sequence is reached until the leaf or catch spring 82 retakes its preferential position. In this stable position of the leaf or catch spring 82 the lock element 26 is again in the open position.

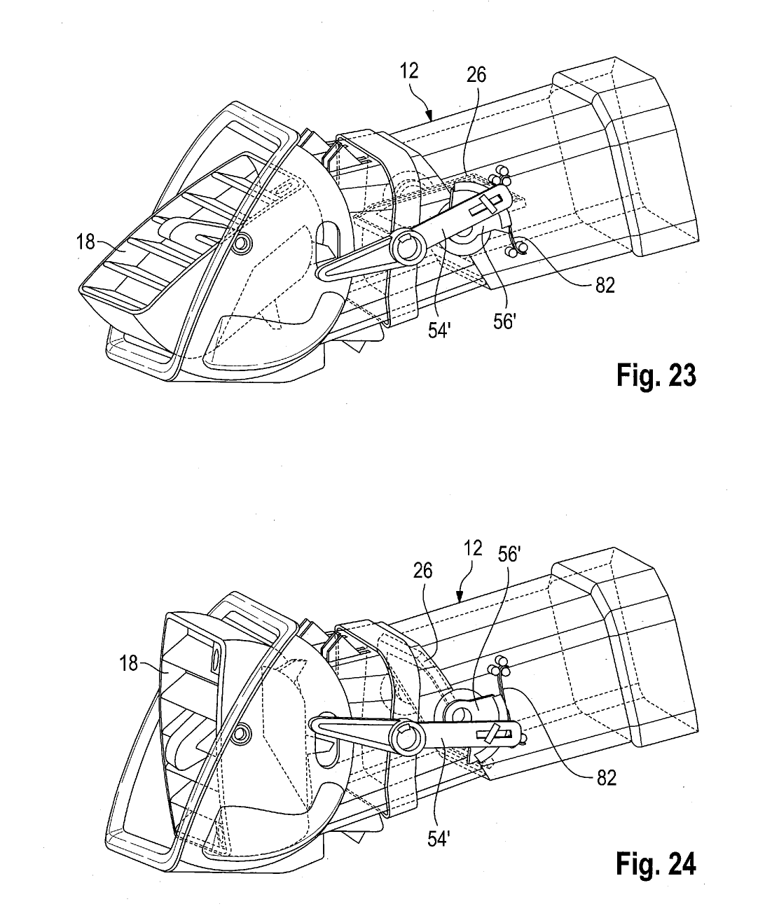

Of course the lever construction 28 can be configured in a manner that the switch from the first operation position with open lock element 26 into the second operation position with closed lock element 26 by swiveling the lamellae carrier 18 beyond the lower end position is reached and vice versa, like in the second variant of the fifth embodiment of an air vent 10 which is shown in the FIGS. 23 and 24.

In this second variant the rocker element 54′ and the rotary element 56′ do not comprise toothings (see FIG. 19). Instead, the second section 76 of the rocker element 54′ comprises an elongated guide 84 within which it is guided an axial pin 58 at the extension 34 (lobe section) of the rotary element 56′. This results in a kinematics similar to that of the first variant of the fifth embodiment. In FIG. 23 the air vent 10 is shown in the first operation position with open lock elements 26, and in FIG. 24 it is shown in the second operation position with closed lock elements 26.

In the fifth embodiment the leaf or catch spring 82 can be provided on the rotary element 56, 56′. In this case the extension 34 (lobe section) is provided at the housing 12 or at a component attached to the housing. Instead of the leaf or catch spring 82 also another spring element can be used which can take two stable positions.

All the embodiments have in common that the push-push mechanism is activated by pressing or overpressing the lamellae carrier 18, which is in a particular use position, into an operation direction. In the first two and the fourth and fifth embodiments, the use position corresponds to the lower, upper or another defined end position of the lamellae carrier 18, that means a particular swivel angle of the lamellae carrier 18. In the third embodiment the use position corresponds to the normal installation situation of the lamellae carrier 18 in the housing 12 where it is pretensioned by a spring element, independently of an optional swiveling of the lamellae carrier 18 around a rotary axis.

Of course specific aspects of the described embodiments can be replaced and/or combined with each other.

### LIST OF REFERENCE SIGNS

10 air vent

12 housing

14 connecting piece

16 air outlet opening

18 lamellae carrier

20 frame of the lamellae carrier

22 lamellae

24 operating element

26 lock element

28 lever construction

30 push-push unit

32 spring element

34 extension

36 frame of the air outlet opening

38 housing part

40 cover

42 gripper section

44 damper

46 stop

48 link

50 rest lever

52 rest spring element

54, 54′ rocker element

56, 56′ rotary element

58 pin

60 lock spring element

62 fork shaped section

64 recess

66 end section

68 guide

70 first section

72 end stop

74 end stop

76 second section

78 toothing

80 toothing

82 leaf or catch spring

84 guide

1. An air vent for a motor vehicle, comprising
a housing which creates a flow connection between an air inlet region and an air outlet region;
a lamellae carrier movably mounted in the housing; and
a lock element movable between a closed position in which the lock element locks the flow connection and an open position in which the lock element releases the flow connection;
wherein the lamellae carrier and the lock element are parts of a push-push mechanism which is activatable by overpressing the lamellae carrier from a specific use position into an operation direction, wherein by the activation of the push-push mechanism the lock element changes position.

2. The air vent of claim 1, wherein the move direction follows a curve which is determined by the bearing of the lamellae carrier.

3. The air vent of claim 2, wherein the lamellae carrier is swivably mounted in the housing and is activated by overpressing from a defined end position of the lamellae carrier of the push-push mechanism.

4. The air vent of claim 3, wherein the defined end position of the lamellae carrier is defined by a stop.

5. The air vent of claim 2, wherein the lamellae carrier comprises a cover which covers an air outlet opening in the defined end position.

6. The air vent of claim 1, wherein the operation direction is linear.

7. The air vent of claim 6, wherein the lamellae carrier is movably mounted in the housing and the push-push mechanism is activated by pushing the lamellae carrier into the housing.

8. The air vent of claim 1, wherein the lock element is coupled to the lamellae carrier via a lever construction.

9. The air vent of claim 8, wherein the lamellae carrier is swivably mounted in the housing and is activated by overpressing from a defined end position of the lamellae carrier of the push-push mechanism, wherein the lever construction comprises a rocker element which is swiveled by overpressing the lamellae carrier, and a rotary element which, by the swivel movement of the rocker element, rotates the lock element into the open or into the closed position.

10. The air vent of claim 9, wherein the lever construction further comprises a rest lever configured to hold the rocker element in two defined positions.

11. The air vent of claim 10, wherein the rocker element comprises a heart slotted link guide where an extension of the rest lever engages with said heart slotted link guide and can take two stable rest positions.

12. The air vent of claim 9, wherein the push-push mechanism comprises a control element, which interacts with an extension and can take two stable positions.

13. The air vent of claim 12, wherein the control element is attached to the housing and the extension is provided at the rotary element.

14. The air vent of claim 12, wherein the control element is provided at the rotary element and the extension is attached to the housing.

15. The air vent of claim 9, wherein the rocker element and the rotary element are coupled to each other via interacting toothings.

16. The air vent of claim 9, wherein the rocker element and the rotary element via an extension are coupled to the rotary element or at the rocker element and a guide adjusted to the extension is coupled at the rocker element or at the rotary element.

17. The air vent of claim 1, wherein the lock element is formed by a wall of the lamellae carrier.

18. The air vent of claim 1, wherein the push-push mechanism comprises an extension which is alternatively held and released by a push-push unit or is alternatively held by the push-push unit in two different stable positions.

19. The air vent of claim 18, wherein the lock element is coupled to the lamellae carrier via a lever construction and wherein the extension is formed at the lever construction and the push-push unit is attached to the housing.

20. The air vent of claim 18, wherein the extension is provided or mounted at the housing and the push-push unit is provided at the lamellae carrier or vice versa.

21. The air vent of claim 18, wherein the extension is formed at the lock element and the push-push unit is attached to the housing.

22. The air vent of claim 1, wherein the lamellae carrier is at least after a switch of the lock element, pretensioned into the closed position by a spring element into a used position.

23. The air vent of claim 1, wherein the lock element is pretensioned by a spring element into the open or into the closed position.
